(19) United States
(12) Patent Application Publication
(10) Pub. No.: US 2018/0276701 A1
(43) Pub. Date: Sep. 27, 2018

(54) VIRTUAL RESOURCE PROCESSING METHOD, SERVER, AND STORAGE MEDIUM

(71) Applicant: TENCENT TECHNOLOGY (SHENZHEN) COMPANY LIMITED, Shenzhen (CN)

(72) Inventors: Chang HE, Shenzhen (CN); Wei YUAN, Shenzhen (CN)

(73) Assignee: TENCENT TECHNOLOGY (SHENZHEN) COMPANY LIMITED, Shenzhen (CN)

(21) Appl. No.: 15/995,424

(22) Filed: Jun. 1, 2018

Related U.S. Application Data
(63) Continuation of application No. PCT/CN2017/086308, filed on May 27, 2017.

(30) Foreign Application Priority Data
Jun. 3, 2016 (CN) 201610388703.5

(51) Int. Cl. G06Q 30/02; G06Q 20/38; H04W 4/02

(52) U.S. Cl. CPC G06Q 30/0222; H04W 4/023; G06Q 20/387; G06Q 30/0235

(57) ABSTRACT

A virtual resource processing method, a server, and a storage medium are provided. The method includes: receiving at least one virtual resource from at least one first client; receiving a virtual resource request message from a second client; obtaining user characteristic information and/or time information based on the virtual resource request message; selecting at least one virtual resource from the at least one virtual resource according to the user characteristic information and/or the time information; and returning, to the second client, a virtual resource response message carrying the selected at least one virtual resource.

### CROSS-REFERENCE RELATED APPLICATIONS

This application is a continuation of International Application No. PCT/CN2017/086308, filed on May 27, 2017, which claims priority to Chinese Patent Application No. 201610388703.5, entitled “VIRTUAL RESOURCE PROCESSING METHOD, SERVER, AND STORAGE MEDIUM”, filed on Jun. 3, 2016 in the State Intellectual Property Office, the entirety of both being herein incorporated by reference.

### FIELD

Apparatuses, methods, and devices consistent with the present disclosure relate to the field of Internet technologies, and in particular, to a virtual resource processing method, a server, and a storage medium.

### DESCRIPTION OF RELATED ART

As Internet services develop rapidly, users can process various services on the Internet. For example, a user can purchase an article by using a virtual resource on the Internet for convenience of everyday life. For example, the user uses a shopping voucher, a coupon, or a red envelope obtained from a merchant.

### SUMMARY

According to one or more exemplary embodiments of this application, a virtual resource processing method is provided. The method includes:

receiving at least one virtual resource from at least one first client;

receiving a virtual resource request message from a second client;

obtaining user characteristic information and/or time information based on the virtual resource request message;

selecting at least one virtual resource from the at least one virtual resource according to the user characteristic information and/or the time information; and

returning, to the second client, a virtual resource response message carrying the selected at least one virtual resource.

According to one or more exemplary embodiments of this application, a server is provided. The server includes:

a receiving module configured to: receive at least one virtual resource from at least one first client; and receive a virtual resource request message from a second client;

an obtaining module configured to obtain user characteristic information and/or time information based on the virtual resource request message received by the receiving module;

a selection module configured to select, according to the user characteristic information and/or the time information obtained by the obtaining module, at least one virtual resource from the at least one virtual resource received by the receiving module; and

a sending module configured to return, to the second client, a virtual resource response message carrying the at least one virtual resource selected by the selection module.

According to one or more exemplary embodiments of this application, a non-volatile computer readable storage medium storing a computer readable instruction being capable of causing at least one processor to perform the method described above.

### BRIEF DESCRIPTION OF THE DRAWINGS

To describe the technical solutions in embodiments of the present application more clearly, the following briefly describes the accompanying drawings required for describing the embodiments. Apparently, the accompanying drawings in the following description show merely some embodiments of the present application, and a person of ordinary skill in the art may still derive other drawings from these accompanying drawings without creative efforts.

FIG. 1 is a schematic structural diagram of an implementation environment according to an exemplary embodiment of the present application;

FIG. 2 is an exemplary flowchart of a virtual resource processing method according to an exemplary embodiment of the present application;

FIG. 3 is an exemplary flowchart of a virtual resource processing method according to another exemplary embodiment of the present application;

FIG. 4 is an interaction flowchart of a virtual resource processing method according to an exemplary embodiment of the present application;

FIG. 5 is a schematic diagram of an interface showing that a user selects a virtual resource according to an exemplary embodiment of the present application;

FIG. 6 is a schematic structural diagram of a server according to an exemplary embodiment of the present application; and

FIG. 7 is a schematic structural diagram of a server according to another exemplary embodiment of the present application.

### DESCRIPTION OF EXEMPLARY EMBODIMENTS

The following clearly and completely describes the technical solutions in the exemplary embodiments of the present application with reference to the accompanying drawings in the embodiments of the present application. Apparently, the described exemplary embodiments are some embodiments of the present application rather than all of the embodiments. All other embodiments obtained by a person of ordinary skill in the art based on the exemplary embodiment of the present application without creative efforts fall within the protection scope of the present application.

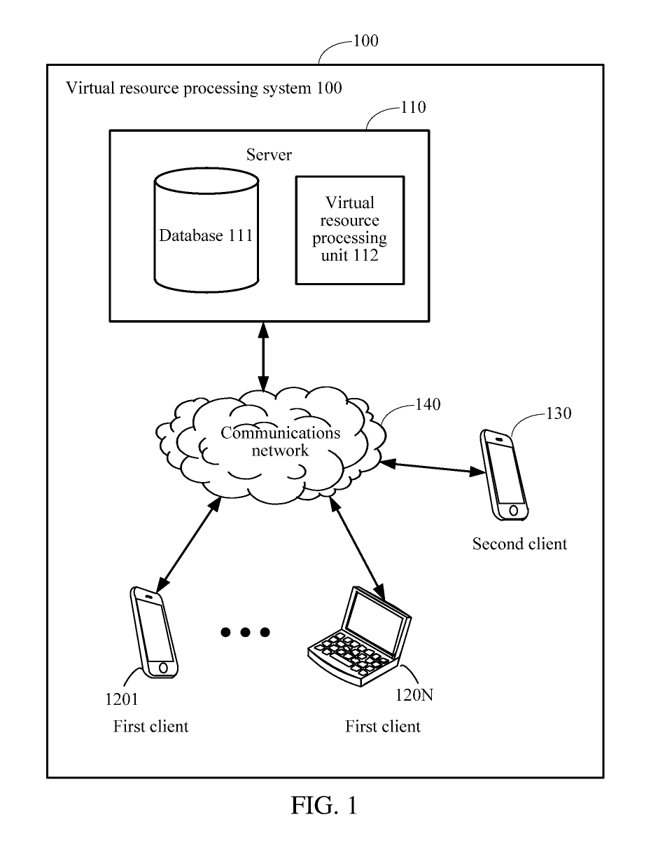

FIG. 1 is a schematic structural diagram of an implementation environment according to an exemplary embodiment of the present application. As shown in FIG. 1, a virtual resource processing system 100 includes a server 110, at least one first client 1201 to 120N, a second client 130, and a communications network 140. In this exemplary embodiment, the at least one first client 1201 to 120N uploads a configured virtual resource to the server 110, for example, a shopping voucher, a coupon, or a red envelope. The second client 130 obtains the virtual resource from the server 110.

The server 110 includes a database 111 and a virtual resource processing unit 112. The database 111 is configured to store the virtual resource uploaded by the at least one first client 1201 to 120N and various data used during selection of a virtual resource. The virtual resource processing unit 112 is configured to select the virtual resource returned to the second client.

The at least one first client 1201 to 120N is used as a virtual resource configuration party, provides an article exchange platform, and configures multiple virtual resources for the article exchanges. The first client may be installed on an electronic device such as a smartphone (for example, 1201), a palmtop computer (for example, 120N), or a tablet computer.

The second client 130 is used as a virtual resource requester and user, and carries out, on the article exchange platform provided by the first client, a transaction by using the virtual resource requested from the server. The second client 130 also may be installed on an electronic device such as a smartphone (for example, 130), a palmtop computer, or a tablet computer.

The first client 1201 to 120N, the second client 130, and the server 110 communicate with each other by using the communications network 140 in a wireless or a wired manner.

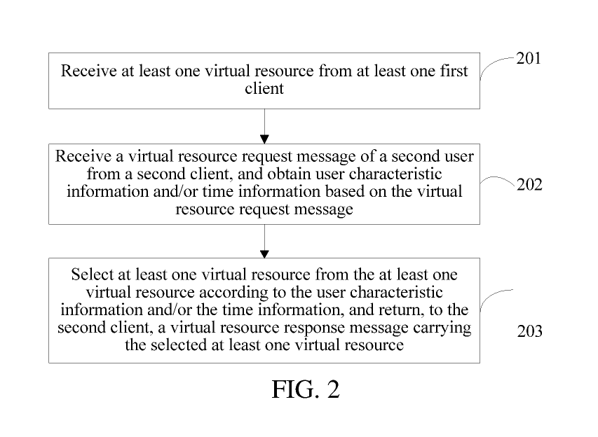

FIG. 2 is an exemplary flowchart of a virtual resource processing method according to an exemplary embodiment of the present application. The method is applied to a server. As shown in the FIG. 2, the method includes the following steps:

Step 201: Receive at least one virtual resource from at least one first client.

Each first client is used as a virtual resource configuration party. For example, a merchant or a seller configures one or more virtual resources according to a commodity promotion requirement of the merchant or the seller, and sets an identifier, a password, a specific value, and the like for each virtual resource. Different virtual resources may have a same value or different values. A value of a virtual resource may be represented in a form of cash (such as a red envelope with a particular amount), or in a form of refund once a required amount is reached (such as a coupon), or in a form of discount (such as a discount coupon), or the like.

Step 202: Receive a virtual resource request message of a second user from a second client, and obtain user characteristic information and/or time information based on the virtual resource request message.

In this step, the second client receives an instruction initiated by the second user on requesting a virtual resource, and sends the virtual resource request message the server. The server obtains the user characteristic information and/or the time information based on the virtual resource request message. The user characteristic information may include any one or more of a current location of the second client, personal attribute information (such as gender, age, region, or marital status) of the second user, or historical behavior information (such as a shopping list of the second user, or information about a previously used virtual resource) of the second user.

In a specific implementation, the virtual resource request message carries an identifier of the second user, so that the server obtains the personal attribute information and the historical behavior information of the second user from a user database according to the identifier of the second user.

There are three manners of obtaining the current location of the second client as follows:

Manner 1: The virtual resource request message carries the current location of the second client, and the server reads the virtual resource request message, to obtain the current location of the second client.

The second client obtains the current location of the second client by using a positioning module in a terminal device of the second client. For example, the second client uses a global positioning system (GPS) positioning module to obtain a two-dimensional location information (a longitude and a latitude) of the second client, and reports the current location to the server when requesting a virtual resource. In this case, accuracy of the current location depends on positioning accuracy of the GPS positioning module outdoors and in an indoor environment.

Manner 2: The server obtains an Internet Protocol (IP) address of the second client, and determines the current location of the second client according to the IP address.

For example, the server obtains the IP address of the second client by using a wireless network connection interface, and then queries an IP address database to determine a specific location of the second client that corresponds to the IP address.

Manner 3: The server obtains a location of a third client connected to the second client, and determines the current location of the second client according to the location of the third client and coverage of the third client.

For example, the terminal device of the second client communicates with the server by using a wireless communications network provided by a telecommunications operator or a Wi-Fi wireless network. In this case, the third client connected to the second client is referred to as an access point (AP) client. Therefore, the server queries an AP database to obtain a specific geographical location of the AP client, and then determines the current location of the second client by using the specific geographical location of the AP client and coverage of the AP client. For example, if the second user uses a Wi-Fi network in a shopping mall to communicate with the server, the server determines, according to a specific geographical location of a connected Wi-Fi AP client and coverage of the Wi-Fi AP client, that the second user is currently within a Starbucks on the second floor of the shopping mall.

In manner 2 and manner 3, the second client does not need to report the current location of the second client, and accuracy of the current location obtained in manner 3 is higher than that of the current location obtained in manner 2.

In addition, the time information is a moment at which the second user requests a virtual resource. Specifically, the server uses a moment at which the virtual resource request message is received as the moment at which the second user requests the virtual resource. Alternatively, the virtual resource request message carries the moment at which the second user requests to use the virtual resource. In this case, the server reads the virtual resource request message, and uses the moment at which the second user requests to use the virtual resource as the moment at which the second user requests the virtual resource.

Step 203: Select at least one virtual resource from the at least one virtual resource according to the user characteristic information and/or the time information, and return, to the second client, a virtual resource response message carrying the selected at least one virtual resource.

For example, at least one virtual resource is selected from the at least one virtual resource according to the current location of the second client in the user characteristic information, or selection is performed according to the time information, or multidimensional selection is performed according to the current location of the second client in the user characteristic information, the personal attribute information of the second user, the historical behavior information of the second user, and the time information.

According to the foregoing exemplary embodiment, user characteristic information and/or time information is obtained based on a virtual resource request message, at least one virtual resource is selected from at least one virtual resource according to the user characteristic information and/or the time information, and a virtual resource response message carrying the selected at least one virtual resource is returned to the second client, so that pushing of the virtual resource is associated with a user that initiates a request. By means of big data statistics collection and analysis based on user characteristic information and time information, a user requirement can be accurately located, and usage of a virtual resource is improved, thereby improving resource usage of a client when a virtual resource is being used.

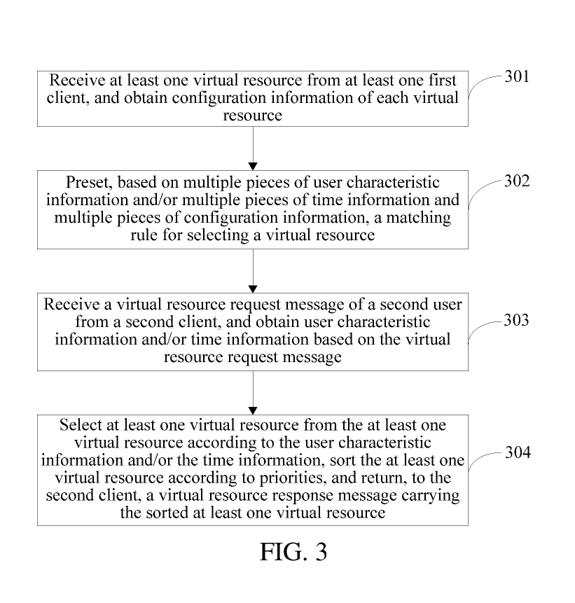

FIG. 3 is an exemplary flowchart of a virtual resource processing method according to another exemplary embodiment of the present application. The method is applied to a server. As shown in the FIG. 3, the method includes the following steps:

Step 301: Receive at least one virtual resource from at least one first client, and obtain configuration information of each virtual resource.

In this step, the server receives a virtual resource and configuration information of each virtual resource from each first client, and creates a virtual resource information table. The configuration information includes any one or more of a value of the virtual resource, a type of the virtual resource, a location for using the virtual resource, or a time period for using the virtual resource.

Table 1 is a virtual resource information table according to an exemplary embodiment of the present application. As shown in Table 1, the virtual resource information table includes N virtual resources, and for each virtual resource, a sequence number, a password, an amount, and a type of the virtual resource, and a location (that is, a merchant location) and a time period for using the virtual resource are provided. For example, for a virtual resource numbered 1, an amount is 15 yuan, a type is taxi coupon, a merchant location is provided by using a specific map picture plus a merchant location identifier, and there is no specific limitation on a time period. For another example, for a virtual resource numbered 3, an amount is 50 yuan, a type is a red envelope for breakfast, an address is Western Restaurant 2F Pangu Plaza, and a time period for using the red envelop is 7 a.m. to 9 a.m.

TABLE 1
Virtual resource information table

| | | Configuration information | | | | |
|---|---|---|---|---|---|---|
| | | | | | | Time period for |
| | | | | | | using a virtual |
| No. | Password | Value | | Type | Merchant location | resource |
| 1 | Pom,cx12 | 15 | yuan | Taxi coupon | Map picture + merchant | — |
| | | | | | location identifier | |
| 2 | lu%\hat{ }&qg# | 3 | hours | Parking coupon | Address: 1F Xueyuan | 2 p.m. to 5 p.m. |
| | | | | | International Plaza, | |
| | | | | | Zhichun Road | |
| 3 | Jxy*LKSu | 50 | yuan | Red envelope for | Address: Western | 7 a.m. to 9 a.m. |
| | | | | breakfast | Restaurant 2F Pangu Plaza | |
| 4 | Etg1sg9s | 20 | yuan | Cash coupon for | Map picture + merchant | 3 p.m. to 6 p.m. |
| | | | | afternoon tea | location identifier | |
| 5 | jkLi&swV | 100 | yuan | Red envelope for | Map picture + merchant | 6 p.m. to 10 p.m. |
| | | | | supper | location identifier | |

| | | | | | |
|---|---|---|---|---|---|
| 6 | jkLiX&sw | 30% off | Discount coupon | Map picture + merchant | 7 a.m. to 11 a.m. |
| | | | for movie ticket | location identifier | |
| . . . | . . . | . . . | . . . | . . . | . . . |
| N | As;j86wz | 50% off | Fitness membership | Map picture + merchant | — |
| | | | discount card | location identifier | |

Step 302: Preset, based on multiple pieces of user characteristic information and/or multiple pieces of time information and multiple pieces of configuration information, a matching rule for selecting a virtual resource.

When obtained user characteristic information and/or obtained time information and configuration information of a virtual resource satisfy the matching rule, the virtual resource is selected. Specifically, there are the following four examples for setting the matching rule according to different obtained information content.

### Example 1

A matching rule for selecting a virtual resource is preset based on a current location of a second client and configuration information.

The configuration information includes an amount of the virtual resource, a type of the virtual resource, and a location for using the virtual resource. In this case, the matching rule includes the following content:

A1: Select a virtual resource if a distance between the current location of the second client and a location for using the virtual resource is less than a first distance threshold.

The current location of the second client represents a current location of the second user, and the location for using the virtual resource represents a merchant location or a seller location. Selection is performed by calculating a distance between the current location of the second client and the location for using the virtual resource.

For example, if the two locations are indicated by two-dimensional GPS coordinates, the current location of the second client is (X₁, Y₁), the location for using the virtual resource is (X₂, Y₂), and a distance between the two is an actual travel distance between the two locations on the map and is indicated as d. If the first distance threshold is d₁, when d≤d₁, it indicates that the second user is near the merchant, and a possibility of using the virtual resource is high. In this case, the virtual resource is selected as one of virtual resources to be returned to the second client. For example, if d₁=500 m, any user within a radius of 500 meters of the merchant can arrive at the merchant quickly to use the virtual resource for article exchanges.

It can be seen that the matching rule associates the current location of the second client with the location of the virtual resource for matching.

A2: A virtual resource is selected if a distance between the current location of the second client and a location for using the virtual resource is greater than a second distance threshold and a type of the virtual resource is a travel allowance type.

If the second distance threshold is d₂, d₂>d₁. When d≥d₂, it indicates that the second user is far away from the merchant. In this case, selection is further performed according to a type of the virtual resource. Specifically, a virtual resource that belongs to a travel allowance type, such as a taxi coupon or a parking coupon, is selected. For example, if d₂=10 km, a user outside a radius of 10 kilometers of the merchant usually takes a taxi or drives to the merchant. In this case, the user may be strongly attracted to a travel allowance type of coupon. Therefore, this type of virtual resource is selected.

It can be seen that the matching rule associates the current location of the second client with the location and type of the virtual resource for matching.

A3: A virtual resource is selected if a distance between the current location of the second client and a location for using the virtual resource is greater than a second distance threshold and a value of the virtual resource is greater than a preset numerical threshold.

When d≥d₂, it indicates that the second user is far away from the merchant. In this case, selection is further performed according to an amount of the virtual resource. Specifically, an amount threshold is preset. When the amount of the virtual resource is greater than the preset numerical threshold, it indicates that the merchant gives a good discount. Although the second user is far away from the merchant, when a travel expense incurred due to a distance between the two is compared with the amount of the virtual resource provided by the merchant, the amount of the virtual resource is greater. For example, if a preset amount threshold is 100 yuan, and a red envelope provided by the merchant is greater than 100 yuan, inevitably, the second user is strongly attracted to the red envelop.

It can be seen that the matching rule associates the current location of the second client with the location and amount of the virtual resource for matching.

### Example 2

A matching rule for selecting a virtual resource is preset based on a current location of a second client, personal attribute information and historical behavior information of a second user, and a location for using the virtual resource.

B1: A virtual resource is selected if a distance between the current location of the second client and a location for using the virtual resource is greater than a second distance threshold, and the historical behavior information of the second user indicates that an article exchange capability of the second user is greater than a preset capability threshold.

The historical behavior information of the second user is a shopping list of the second user within a historical period of time. The article exchange capability, that is, purchasing power, of the second user can be learned according to the shopping list. If the purchasing power of the second user is greater than the preset capability threshold, for example, if the purchasing power within one year is greater than a preset capability threshold 5000 yuan, it indicates that the second user has strong purchasing power, and even if far away from a merchant, the second user may still go to the merchant for shopping. Therefore, the virtual resource is selected.

It can be seen that the matching rule associates the current location of the second client, the historical behavior information of the second user, and the location of the virtual resource with each other for matching.

B2: A virtual resource is selected if a distance between the current location of the second client and a location for using the virtual resource is greater than a second distance threshold, and the historical behavior information of the second user indicates that the second user has used the virtual information for many times.

The historical behavior information of the second user is information of a virtual resource used by the second user in a historical period of time. Preferences of the second user can be learned according to the information. For example, if the second user has used discount coupons of a merchant for multiple times, it indicates that although the second user is far away from the merchant, the second user likes to go to the merchant for shopping. Therefore, the virtual resource is selected.

It can be seen that the matching rule also associates the current location of the second client, the historical behavior information of the second user, and the location of the virtual resource with each other for matching.

B3: A virtual resource is selected if a distance between the current location of the second client and a location for using the virtual resource is greater than a second distance threshold, and the personal attribute information of the second user indicates that a range of motion of the second user is greater than the second distance threshold.

When d≥d₂, it indicates that the second user is far away from the merchant. In this case, preferences of the second user is further determined according to the personal attribute information of the second user. The personal attribute information of the second user includes gender, age, marital status, or the like of the second user. For example, if the second user is female, aged 36, and married, it is determined that the second user is a mother, and the second user is strongly attracted to a children's play center having a distance of d away from the second user. In this case, when the virtual resource is a parking coupon of a children's play center, the parking coupon is selected.

It can be seen that the matching rule associates the current location of the second client, the personal attribute information of the second user, and the location of the virtual resource with each other for matching.

### Example 3

A matching rule for selecting a virtual resource is preset based on multiple pieces of time information and multiple pieces of configuration information.

The time information is a moment at which the second user requests a virtual resource, and the configuration information is a time period for using the virtual resource. In this case, the matching rule associates the moment of the virtual resource with the time period of the virtual resource, and the following cases are specifically included:

C1: A virtual resource is selected if the moment is before a time period for using the virtual resource.

For example, the virtual resource corresponds to foods, for example, breakfast, lunch, supper, or afternoon tea, and the virtual resource is used in a corresponding time period. In this case, if a moment at which the second user requests a virtual resource, for example, a moment at which the server receives a virtual resource request message or a moment that is carried in a virtual resource request message and at which the second user requests to use a virtual resource is before a time period for using the virtual resource, the virtual resource is selected. For example, if the moment at which the second user requests the virtual resource is 3 p.m., and the moment is before a time period from 6 p.m. to 9 p.m. for supper, a selected virtual resource includes a discount coupon, a coupon, a red envelope, or the like for supper.

C2: A virtual resource is selected if the moment is within a time period for using the virtual resource.

For example, if the moment at which the second user requests the virtual resource is 8 a.m., the virtual resource corresponds to a movie ticket, and the time period for using the virtual resource is 7 a.m. to 11 a.m., the selected virtual resource includes a cash coupon, a discount coupon, a coupon, a red envelope, or the like for the movie ticket.

### Example 4

A matching rule for selecting a virtual resource is preset based on multiple pieces of user characteristic information, multiple pieces of time information, and multiple pieces of configuration information.

The user characteristic information includes a current location of a second client and historical behavior information of a second user, the time information is a moment at which the second user requests a virtual resource, and the configuration information includes a type of the virtual resource, a location for using the virtual resource, and a time period for using the virtual resource. The following cases are specifically included for the matching rule:

D1: A virtual resource is selected if a moment at which the virtual resource request message is received is within a time period for using the virtual resource, and if a distance between the current location of the second client and a location for using the virtual resource is less than a first distance threshold.

For example, the second user hopes to obtain a virtual resource for temporary consumption. If in the foregoing example, the moment at which the second user requests the virtual resource is 8 a.m., the virtual resource corresponds to a movie ticket, and a time period for using the virtual resource is 7 a.m. to 11 a.m., a virtual resource of a merchant closer to the second user is further selected from virtual resources that can be used within the time period.

It can be seen that the matching rule associates the current location of the second client, the time information, and the location for using the virtual resource with each other for matching.

D2: A virtual resource is selected if the historical behavior information of the second user indicates that a type of the virtual resource is the same as a type of a virtual resource to be used by the second user after the moment.

For example, the historical behavior information of the second user is a virtual resource previously used by the user. In this way, a type of a virtual resource to be used by the second user after the moment at which the virtual resource is used can be learned, thereby obtaining the virtual resource through matching according to the type. For example, if the historical behavior information of the second user indicates that the user usually goes to the gym 7 p.m. to 9 p.m., and currently, the moment at which the second user requests a virtual resource is 5 p.m., a fitness-type virtual resource is selected, for example, a coupon, a discount coupon, or a red envelope of a gym or a swimming pool.

It can be seen that the matching rule associates the historical behavior information of the second user, the time information, and the type of the virtual resource with each other for matching.

It should be noted that the multiple matching rules described above are only examples. During specific implementation, each matching rule may be used independently, or the matching rules may be combined to select a suitable virtual resource by using multidimensional data information.

Specifically, the user characteristic information includes three information items, they are: the current location of the second client, the personal attribute information of the second user, and the historical behavior information of the second user. The configuration information includes four information items, they are: an amount of the virtual resource, the type of the virtual resource, the location for using the virtual resource, and the time period for using the virtual resource. In combination with the foregoing time information, the matching rule is related to the eight-dimensional information. The personal attribute information of the user may further include content such as gender, age, region, marital status, and income. The historical behavior information of the user includes content such as a shopping list of the user and information of a previously used virtual resource.

Table 2 is a matching rule setting table according to an exemplary embodiment of the present application. As shown in Table 2, the matching rule setting table includes M matching rules and multidimensional information (identified by √ in the eight items of information) corresponding to each matching rule. For example, information associated with a matching rule numbered 1 includes six dimensions: a current location, personal attribute information, time information, a type, a location for use, and a time period for use. For another example, information associated with a matching rule numbered M includes all the foregoing eight-dimensional information. It can be seen that a larger quantity of information items associated with a matching rule indicates high accuracy of selecting a virtual resource and a closer approach to a usage requirement of a user.

TABLE 2
Matching rule setting table

| | Multidimensional information | | | | | | | |
|---|---|---|---|---|---|---|---|---|
| | | | | | Configuration information of a | | | |
| Sequence | User characteristic information | | | | virtual resource | | | |
| number of | | Personal | Historical | | | | | Time |
| a matching | Current | attribute | behavior | Time | | | Location n | period |
| rule | location | information | information | information | Value | Type | for use | for use |
| 1 | ✓ | ✓ | | ✓ | | ✓ | ✓ | ✓ |
| 2 | ✓ | | ✓ | ✓ | ✓ | | ✓ | ✓ |
| . . . | . . . | . . . | . . . | . . . | . . . | . . . | . . . | . . . |
| M | ✓ | ✓ | ✓ | ✓ | ✓ | ✓ | ✓ | ✓ |

Step 303: Receive a virtual resource request message of a second user from a second client, and obtain user characteristic information and/or time information based on the virtual resource request message.

Step 304: Select at least one virtual resource from the at least one virtual resource according to the user characteristic information and/or the time information, sort the at least one virtual resource according to priorities, and return, to the second client, a virtual resource response message carrying the sorted at least one virtual resource.

At least one virtual resource is selected from multiple virtual resources according to various matching rules in step 302. If the virtual resource request message carries priorities for the user characteristic information and the time information, when multiple virtual resources are selected, the multiple virtual resources are sorted in descending order according to the priorities, and the first L virtual resources are used in descending order as virtual resources to be returned to the second client, where L is a positive integer greater than 1.

For example, when requesting a virtual resource, if the second user specifies, in descending order, priorities of information used during selection as follows: the current location of the second client, the time information, and the historical behavior information of the second user, the multiple virtual resources selected according to the foregoing matching rules are sorted according to the foregoing priorities, and the first L virtual resources are selected as resources to be returned to the second client. For example, L=5.

By means of the foregoing exemplary embodiments, a matching rule for selecting a virtual resource is preset based on multiple pieces of user characteristic information and/or multiple pieces of time information and multiple pieces of configuration information, and association may be performed by using eight-dimensional information (a current location of a second client, personal attribute information of a second user, historical behavior information of the second user, a moment at which a virtual resource is requested, an amount of the virtual resource, a type of the virtual resource, a location for using the virtual resource, and a time period for using the virtual resource). By means of such big data analysis, a selected virtual resource conforms to user personal characteristics, a current location, and a moment at which the virtual resource is requested, thereby implementing personalized pushing of the virtual resource requested by the user, meeting usage requirements of the user at different geographical locations or in a different scenario such as a temporary consumption scenario, greatly improving usage of the virtual resource and user experience, and improving resource usage of a client.

In addition, virtual resources in which the user is interested are sorted according to priorities, set by the user, of user characteristic information and time information, thereby improving an acceptance rate of a pushed virtual resource, and further improving the resource usage of the client.

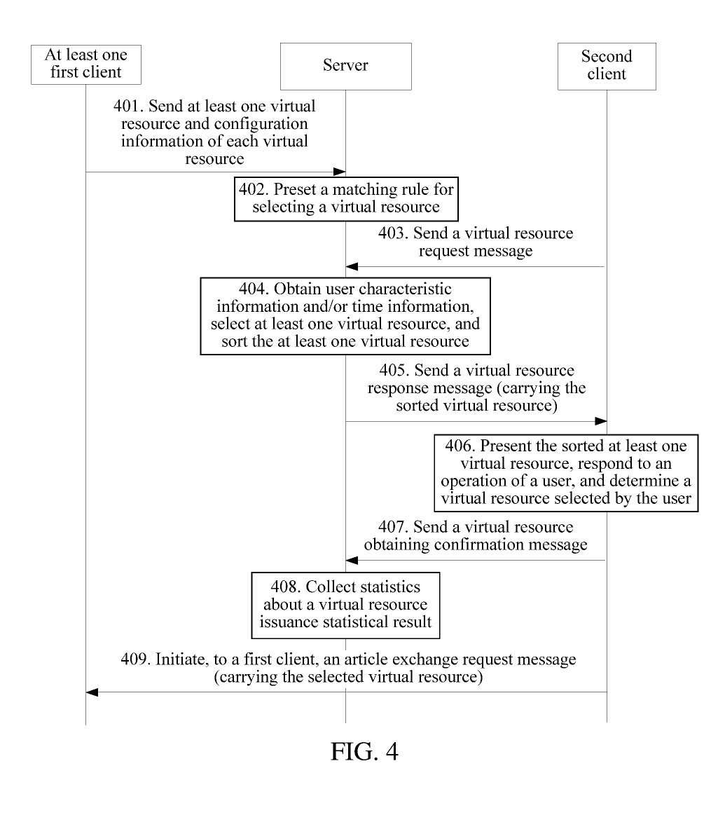

FIG. 4 is an interaction flowchart of a virtual resource processing method according to an exemplary embodiment of the present application, including interaction between a first client (used as a virtual resource configuration party), a second client (used as a virtual resource requester and user), and a server. The method includes the following steps:

Step 401: At least one first client sends at least one virtual resource and configuration information of each virtual resource to the server.

Each first client sends at least one virtual resource to the server.

Step 402: The server presets, based on multiple pieces of user characteristic information and/or multiple pieces of time information and multiple pieces of configuration information, a matching rule for selecting a virtual resource.

Step 403: The second client sends a virtual resource request message of a second user to the server.

Step 404: The server obtains user characteristic information and/or time information based on the virtual resource request message, selects at least one virtual resource from the at least one virtual resource according to the user characteristic information and/or the time information, and sorts the at least one virtual resource according to priorities.

The virtual resource request message may carry an identifier of the second user, a current location of the second client, a moment at which the second user requests to use a virtual resource, and priorities of the user characteristic information and the time information.

Step 405: The server returns, to the second client, a virtual resource response message carrying the sorted at least one virtual resource.

Step 406: The second client presents the sorted at least one virtual resource, responds to an operation of the second user, and determines a virtual resource selected by the user.

The second client sequentially presents, in a display interface in an order of the sorting, an amount, a type, a merchant location, a time period for use, or the like of each virtual resource. Then, the user selects, according to a requirement of the user at that time, a virtual resource to be used.

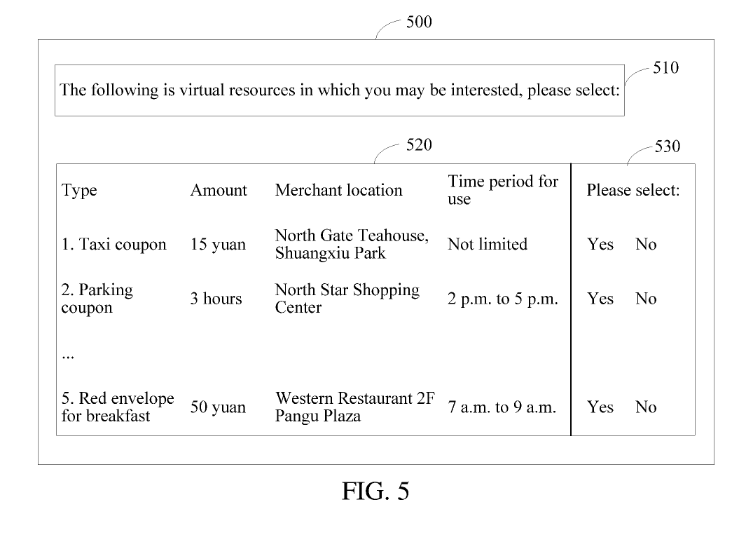

FIG. 5 is a schematic diagram of an interface showing that a user selects a virtual resource according to an exemplary embodiment of the present application. As shown in FIG. 5, in a display interface 500 of a second client, prompt information: “The following is virtual resources in which you may be interested, please select:” is displayed in a box 510, and five sorted virtual resources are listed in a box 520, including a type, an amount, a merchant location, and a time period for use of each virtual resource. For example, for the first virtual resource, a type of is taxi coupon, an amount is 15 yuan, a merchant location is “North Gate Teahouse, Shuangxiu Park”, and a time period for use is not limited. In a box 530, selection options: “Yes” and “No” are output, so that a second user selects a virtual resource to be used by the second user from the five virtual resources.

Step 407: A second client sends, to a server, a virtual resource obtaining confirmation message carrying a selected virtual resource.

An identifier of the selected virtual resource and an identifier of the second user are added to the virtual resource obtaining confirmation message based on a selection instruction of the second user, to return, to the server, the virtual resource obtained by the user.

Step 408: The server collects, based on received at least one virtual resource obtaining confirmation message, statistics about a virtual resource issuance statistical result.

The server collects, based on the received identifier of the virtual resource and the received identifier of the second user, statistics about a quantity of users to which each virtual resource is sent and an identifier of each user, and stores the quantity of users and the identifier of each user. Theses issuance statistical results are to be used for estimating pushing effects of the virtual resources.

Step 409: The second client initiates, to a first client, an article exchange request message carrying the selected virtual resource, to start an article exchange process.

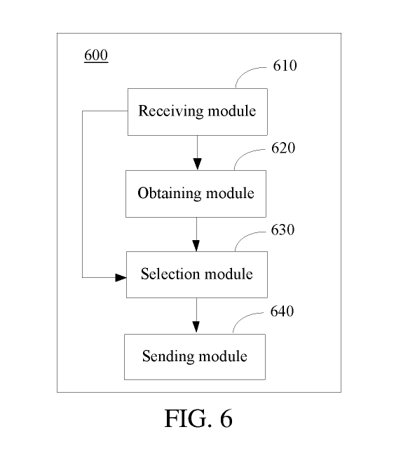

FIG. 6 is a schematic structural diagram of a server 600 according to an exemplary embodiment of the present application. As shown in FIG. 6, the server 600 includes:

a receiving module 610 configured to: receive at least one virtual resource from at least one first client; and receive a virtual resource request message of a second user from a second client;

an obtaining module 620 configured to obtain user characteristic information and/or time information based on the virtual resource request message received by the receiving module 610;

a selection module 630 configured to select, according to the user characteristic information and/or the time information obtained by the obtaining module 620, at least one virtual resource from the at least one virtual resource received by the receiving module 610; and

a sending module 640 configured to return, to the second client, a virtual resource response message carrying the at least one virtual resource selected by the selection module 630.

In an exemplary embodiment, the receiving module 610 is further configured to obtain configuration information of each virtual resource.

The selection module 630 is further configured to: preset, based on multiple pieces of user characteristic information and/or multiple pieces of time information and multiple pieces of configuration information received by the receiving module 610, a matching rule for selecting a virtual resource, where a virtual resource is selected when the user characteristic information and/or the time information and configuration information of the virtual resource meet the matching rule.

In an exemplary embodiment, the user characteristic information includes a current location of the second client, and the configuration information includes a value of the virtual resource, a type of the virtual resource, and a location for using the virtual resource, and the selection module 630 is configured to:

select a virtual resource if a distance between the current location of the second client and a location for using the virtual resource is less than a first distance threshold; and/or

select a virtual resource if a distance between the current location of the second client and a location for using the virtual resource is greater than a second distance threshold and a type of the virtual resource is a travel allowance type; and/or

select a virtual resource if a distance between the current location of the second client and a location for using the virtual resource is greater than a second distance threshold and a value of the virtual resource is greater than a preset numerical threshold.

In an exemplary embodiment, the user characteristic information includes a current location of the second client, and personal attribute information and historical behavior information of a second user. The configuration information includes a location for using the virtual resource. The selection module 630 is configured to:

select a virtual resource if a distance between the current location of the second client and a location for using the virtual resource is greater than a second distance threshold, and the historical behavior information of the second user indicates that an article exchange capability of the second user is greater than a preset capability threshold; and/or

select a virtual resource if a distance between the current location of the second client and a location for using the virtual resource is greater than a second distance threshold, and the historical behavior information of the second user indicates that the second user has used the virtual information for many times; and/or

select a virtual resource if a distance between the current location of the second client and a location for using the virtual resource is greater than a second distance threshold, and the personal attribute information of the second user indicates that a range of motion of the second user is greater than the second distance threshold.

In an exemplary embodiment, the time information is a moment at which the second user requests a virtual resource, the configuration information is a time period for using the virtual resource, and the selection module 630 is configured to:

select a virtual resource if the moment is before a time period for using the virtual resource; and/or

select a virtual resource if the moment is within a time period for using the virtual resource.

In an exemplary embodiment, the user characteristic information includes a current location of the second client and historical behavior information of a second user, the time information is a moment at which the second user requests a virtual resource, and the configuration information includes a type of the virtual resource, a location for using the virtual resource, and a time period for using the virtual resource. The selection module 630 is configured to:

select a virtual resource if a moment at which the virtual resource request message is received is within a time period for using the virtual resource, and if a distance between the current location of the second client and a location for using the virtual resource is less than a first distance threshold; and/or

select a virtual resource if the historical behavior information of the second user indicates that a type of the virtual resource is the same as a type of a virtual resource to be used by the second user after the moment.

In an exemplary embodiment, the virtual resource request message carries priorities for the user characteristic information and the time information, and the selection module 630 is further configured to: sort, when multiple virtual resources are selected, the multiple virtual resources in descending order according to the priorities, and use the first L virtual resources in descending order as at least one virtual resource to be returned to the second client, where L is a positive integer greater than 1.

In an exemplary embodiment, the obtaining module 620 is configured to:

read the virtual resource request message when the virtual resource request message carries the current location of the second client, to obtain the current location of the second client; or

obtain an Internet Protocol address of the second client, and determine the current location of the second client according to the Internet Protocol address; or

obtain a location of a third client connected to the second client, and determine the current location of the second client according to the location of the third client and coverage of the third client.

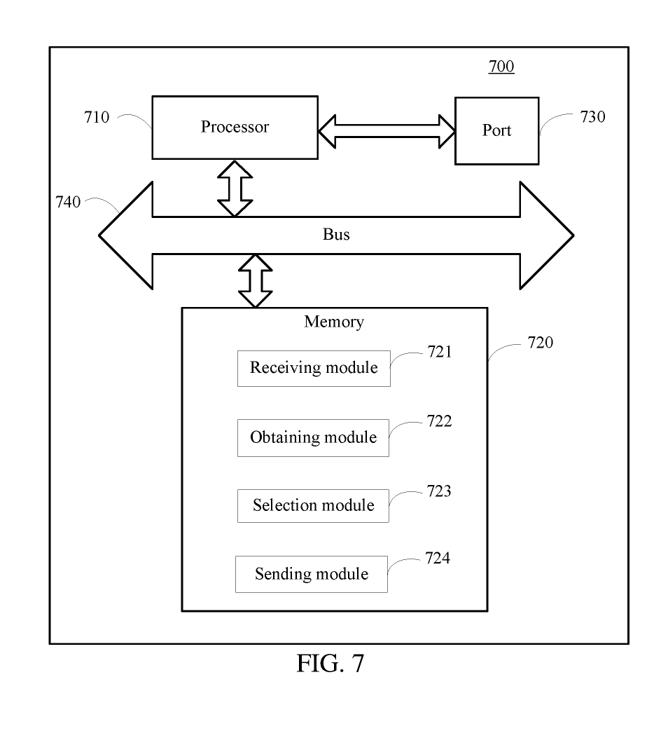

FIG. 7 is a schematic structural diagram of a server 700 according to another exemplary embodiment of the present application. The server 700 includes a processor 710, a memory 720, a port 730, and a bus 740. The processor 710 and the memory 720 are interconnected by using the bus 740. The processor 710 may receive or send data by using the port 730.

The processor 710 is configured to execute a machine-readable instruction module stored in the memory 720.

The memory 720 stores the machine-readable instruction module that can be executed by the processor 710. The instruction module that can be executed by the processor 710 includes: a receiving module 721, an obtaining module 722, a selection module 723, and a sending module 724.

When executed by the processor 710, the receiving module 721 may: receive at least one virtual resource from at least one first client; and receive a virtual resource request message of a second user from a second client.

When executed by the processor 710, the obtaining module 722 may obtain user characteristic information and/or time information based on the virtual resource request message received by the receiving module 721.

When executed by the processor 710, the selection module 723 may select, according to the user characteristic information and/or the time information obtained by the obtaining module 722, at least one virtual resource from the at least one virtual resource received by the receiving module 721.

When executed by the processor 710, the sending module 724 may return, to the second client, a virtual resource response message carrying the at least one virtual resource selected by the selection module 723.

It may be seen that when the instruction module stored in the memory 720 is executed by the processor 710, various functions of the receiving module, the obtaining module, the selection module, and the sending module in the foregoing instances can be implemented.

In the foregoing apparatus and system embodiments, specific methods used by the modules and units to implement functions of the modules and units are described in the method embodiments. Details are not described herein again.

In addition, function modules in the exemplary embodiments of the present application may be integrated into one processing module, or each of the modules may exist alone physically, or two or more modules may be integrated into one unit. The integrated unit may be implemented in a form of hardware, or may be implemented in a form of a software functional unit.

In addition, each exemplary embodiment of the present application may be implemented by a data processing program executed by a data processing device such as a computer. Apparently, the data processing program constitutes this application. In addition, generally, a data processing program stored in a storage medium is directly read from the storage medium for execution or the program is installed on or replicated to a storage device (such as a hard disk or memory) of a data processing device for execution. Therefore, such a storage medium also constitutes this application. The storage medium may use any type of recording manner, such as a paper storage medium (such as a paper tape), a magnetic storage medium (such as a floppy disk, a hard disk, or a flash memory), an optical storage medium (such as a CD-ROM), or a magneto-optical storage medium (such as an MO).

Therefore, this application further discloses a storage medium, which stores a data processing program. The data processing program is used for performing any instance of the foregoing method of this application.

The foregoing descriptions are merely preferred exemplary embodiments of the present application, but are not intended to limit this application. Any modification, equivalent replacement, or improvement made within the spirit and principle of this application shall fall within the protection scope of this application.

What is claimed is:

1. A virtual resource processing method performed by at least one processor, comprising:
receiving at least one virtual resource from at least one first client;
receiving a virtual resource request message from a second client;
obtaining at least one of user characteristic information and time information based on the virtual resource request message;
selecting a virtual resource from the at least one virtual resource according to at least one of the user characteristic information and the time information; and
returning, to the second client, a virtual resource response message carrying the selected at least one virtual resource.

2. The method according to claim 1, further comprising:
obtaining configuration information of each virtual resource; and
presetting, based on at least one of multiple pieces of user characteristic information, multiple pieces of time information and multiple pieces of configuration information, a matching rule for selecting a virtual resource, wherein
the virtual resource is selected when at least one of the user characteristic information, the time information and configuration information of the virtual resource meets the matching rule.

3. The method according to claim 2, wherein:
the user characteristic information comprises a current location of the second client; and
the configuration information comprises a value of the virtual resource, a type of the virtual resource, and a location for using the virtual resource.

4. The method according to claim 3, wherein the presetting further comprises at least one of:
selecting the virtual resource if a distance between the current location of the second client and a location for using the virtual resource is less than a first distance threshold;
selecting the virtual resource if a distance between the current location of the second client and a location for using the virtual resource is greater than a second distance threshold and a type of the virtual resource is a travel allowance type; and
selecting the virtual resource if a distance between the current location of the second client and a location for using the virtual resource is greater than a second distance threshold and a value of the virtual resource is greater than a preset numerical threshold.

5. The method according to claim 2, wherein the user characteristic information comprises a current location of the second client, and personal attribute information and historical behavior information of a second user; and the configuration information comprises a location for using the virtual resource.

6. The method according to claim 5, wherein the presetting further comprises at least one of:
selecting the virtual resource if a distance between the current location of the second client and a location for using the virtual resource is greater than a second distance threshold, and the historical behavior information of the second user indicates that an article exchange capability of the second user is greater than a preset capability threshold;
selecting the virtual resource if a distance between the current location of the second client and a location for using the virtual resource is greater than a second distance threshold, and the historical behavior information of the second user indicates that the second user has used the virtual resource for many times; and
selecting the virtual resource if a distance between the current location of the second client and a location for using the virtual resource is greater than a second distance threshold, and the personal attribute information of the second user indicates that a range of motion of the second user is greater than the second distance threshold.

7. The method according to claim 2, wherein:
the time information is a moment at which the second user requests a virtual resource; and
the configuration information is a time period for using the virtual resource.

8. The method according to claim 7, wherein the presetting further comprises at least one of:
selecting the virtual resource if the moment is before a time period for using the virtual resource; and
selecting the virtual resource if the moment is within a time period for using the virtual resource.

9. The method according to claim 2, wherein:
the user characteristic information comprises a current location of the second client and historical behavior information of a second user;
the time information is a moment at which the second user requests a virtual resource; and
the configuration information comprises a type of the virtual resource, a location for using the virtual resource, and a time period for using the virtual resource.

10. The method according to claim 9, wherein the presetting further comprises at least one of:
selecting the virtual resource if a moment at which the virtual resource request message is received is within a time period for using the virtual resource, and if a distance between the current location of the second client and a location for using the virtual resource is less than a first distance threshold; and
selecting the virtual resource if the historical behavior information of the second user indicates that a type of the virtual resource is the same as a type of a virtual resource to be used by the second user after the moment.

11. The method according to claim 1, further comprising:
sorting, when multiple virtual resources are selected, the multiple virtual resources in descending order according to the priorities, and using the first L virtual resources in descending order as at least one virtual resource to be returned to the second client, wherein L is a positive integer greater than 1,
wherein the virtual resource request message carries priorities for the user characteristic information and the time information.

12. The method according to claim 1, wherein the obtaining user characteristic information further comprises:
reading the virtual resource request message when the virtual resource request message carries the current location of the second client, to obtain the current location of the second client; or
obtaining an Internet Protocol address of the second client, and determining the current location of the second client according to the Internet Protocol address; or
obtaining a location of a third client connected to the second client, and determining the current location of the second client according to the location of the third client and coverage of the third client.

13. A server, comprising:
at least one memory configured to store computer program code; and
at least one processor configured to access the memory, read the computer program code, and operate as instructed by the computer program code, the computer program code including:
first receiving code configured to cause the at least one processor to receive at least one virtual resource from at least one first client;
second receiving code configured to cause the at least one processor to receive a virtual resource request message from a second client;
obtaining code configured to cause the at least one processor to obtain at least one of user characteristic information and time information based on the received virtual resource request message;
selecting code configured to cause the at least one processor to select, according to at least one of the obtained user characteristic information and the obtained time information, at least one virtual resource from the received at least one virtual resource; and
returning code configured to cause the at least one processor to return, to the second client, a virtual resource response message carrying the selected at least one virtual resource.

14. The server according to claim 13, wherein the computer program code further includes:
obtaining code configured to cause the at least one processor to obtain configuration information of each virtual resource; and
presetting code configured to cause the at least one processor to preset, based on multiple pieces of user characteristic information and/or multiple pieces of time information and multiple pieces of configuration information received by the receiving module, a matching rule for selecting a virtual resource, wherein a virtual resource is selected when the user characteristic information and/or the time information and configuration information of the virtual resource meet the matching rule.

15. A non-volatile computer readable storage medium comprising computer executable instructions that, when executed by one or more processors, the computer executable instructions cause the processors to perform:
receiving at least one virtual resource from at least one first client;
receiving a virtual resource request message from a second client;
obtaining at least one of user characteristic information and time information based on the virtual resource request message;
selecting a virtual resource from the at least one virtual resource according to at least one of the user characteristic information and the time information; and
returning, to the second client, a virtual resource response message carrying the selected at least one virtual resource.

16. The non-volatile computer readable storage medium according to claim 15, wherein the computer executable instructions further cause the processor to perform:
obtaining configuration information of each virtual resource; and
presetting, based on at least one of multiple pieces of user characteristic information, multiple pieces of time information and multiple pieces of configuration information, a matching rule for selecting a virtual resource, wherein
the virtual resource is selected when at least one of the user characteristic information, the time information and configuration information of the virtual resource meets the matching rule.

17. The non-volatile computer readable storage medium according to claim 16, wherein:
the user characteristic information comprises a current location of the second client; and
the configuration information comprises a value of the virtual resource, a type of the virtual resource, and a location for using the virtual resource.

18. The non-volatile computer readable storage medium according to claim 17, wherein the computer executable instructions further cause the processor to perform at least one of:
selecting the virtual resource if a distance between the current location of the second client and a location for using the virtual resource is less than a first distance threshold;
selecting the virtual resource if a distance between the current location of the second client and a location for using the virtual resource is greater than a second distance threshold and a type of the virtual resource is a travel allowance type; and
selecting the virtual resource if a distance between the current location of the second client and a location for using the virtual resource is greater than a second distance threshold and a value of the virtual resource is greater than a preset numerical threshold.

19. The non-volatile computer readable storage medium according to claim 15, wherein the computer executable instructions further cause the processor to perform:
sorting, when multiple virtual resources are selected, the multiple virtual resources in descending order according to the priorities, and using the first L virtual resources in descending order as at least one virtual resource to be returned to the second client, wherein L is a positive integer greater than 1,
wherein the virtual resource request message carries priorities for the user characteristic information and the time information.

20. The non-volatile computer readable storage medium according to claim 15, wherein the computer executable instructions further cause the processor to perform:
reading the virtual resource request message when the virtual resource request message carries the current location of the second client, to obtain the current location of the second client; or
obtaining an Internet Protocol address of the second client, and determining the current location of the second client according to the Internet Protocol address; or
obtaining a location of a third client connected to the second client, and determining the current location of the second client according to the location of the third client and coverage of the third client.
